(19) United States
(12) Patent Application Publication
(10) Pub. No.: US 2013/0252636 A1
(43) Pub. Date: Sep. 26, 2013

(54) Hot Spot Detection

(71) Applicants: John Chang, Stockholm (SE); Shadi Mahassel, London (GB)

(72) Inventors: John Chang, Stockholm (SE); Shadi Mahassel, London (GB)

(21) Appl. No.: 13/426,158

(22) Filed: Mar. 21, 2012

(51) Int. Cl. H04W 4/02; H04W 24/00

(52) U.S. Cl. 455/456.3; 455/456.1

(57) ABSTRACT

The invention relates to a method of locating a wireless access node using a mobile device having wireless access technology. The mobile device carries out the following steps without using the wireless access technology: uses geolocation means on the mobile device to detect the position of the mobile device; compares geolocation data from the geolocation means with access node entries in a store accessible to the mobile device, each access node entry associating a wireless access node with its geolocation data; and automatically identifies a wireless access node which is indicated as a result of the comparison to be in the vicinity of the mobile device.

### TECHNICAL FIELD

The present invention relates to accessing a packet-based network via wireless access points.

### BACKGROUND

Some communication systems allow the user of a device, such as a personal computer, to communicate across a packet-based computer network such as the Internet. Such communication systems include voice over internet protocol (“VoIP”) communication systems. These systems are beneficial to the user as they are often of significantly lower cost than conventional fixed line or mobile networks. This may particularly be the case for long-distance communication. To use a VoIP system, the user installs and executes client software on their device. The client software provides the VoIP connections as well as other functions such as registration and authentication. In addition to voice communication, the client may also provide further features such as video calling, instant messaging (“IM”), SMS messaging, file transfer and voicemail.

One type of communication system for packet-based communication uses a peer-to-peer (“P2P”) topology. To enable access to a peer-to-peer system, a user must execute P2P client software provided by a P2P software provider on their terminal, and register with the P2P system. When the user registers with the P2P system, the client software is provided with a digital certificate from a server. Once the client software has been provided with the certificate, then calls or other communications can subsequently be set up and routed between users of the P2P system without the further use of a server in the set-up. Instead, the client looks up the required IP addresses from information distributed amongst the P2P client software on other end users' terminals within the P2P system. Once the IP address of a callee's terminal has thus been determined, the caller's P2P client software then exchanges certificates with the callee's P2P client software. The exchange of the digital certificates (or user identity certificates, “UIC”) between users provides proof of the users' identities and that they are suitably authorized and authenticated in the P2P system. Therefore, the presentation of digital certificates provides trust in the identity of the users.

It is therefore a characteristic of peer-to-peer communication that, once registered, the users can set up their own communication routes through the P2P system in a decentralized manner based on distributed address look-up and the exchange of one or more digital certificates, without using a server for those purposes. Further details on such a P2P system are disclosed in WO 2005/008524 and WO 2005/009019.

VoIP or other packet-based communications can also be implemented using non-P2P systems that do use centralized call set-up.

A problem with packet-based communication systems is that a reliable connection with a sufficient bandwidth is required to the Internet or other packet-based network. While this is generally not a problem when the user is at a known, fixed location (such as their home), this can be particularly problematic when the user is travelling and must access the packet-based network via a wireless access point. For example, wireless Internet hotspots, provided by wireless local area network (“WLAN”) access points and appropriate hotspot software, are widely available for use by users when travelling. These are often available in public areas and are operated by a third-party service provider other than the provider of the client software.

Herein the term “public Wi-Fi hotspots” refer to wireless networks that offer internet access in publicly accessible areas (such as airports, train stations, hotels, restaurants, cafes, bars, stores, shopping centers, parks, etc). Such wireless networks are generally open (non-password protected), although some may require a password or other form of authentication for access.

When traveling or in other mobile situations, it becomes a common problem for the user to identify hotspots that can be used, either for free or are compatible with services that the user may have already paid for. Some venues offering public Wi-Fi hotspots may be marked with a sticker or sign identifying Wi-Fi access, but most often, the hotspots are not marked, forcing the user to have to go around and hunt for Wi-Fi hotspots. This involves using the Wi-Fi radio on the user's device to scan for available networks and then examining identifying information from each Wi-Fi network (specifically the network name, also known as SSID). The user may recognize specific network names from previous experience, but in the worst case, the user may be forced to try checking each network manually for internet access, one by one.

To address this problem, some hotspot providers offer a website or app that displays a map or directory of supported hotspots. The user then browses the map or directory to look for relevant hotspots. In some cases, it is possible to search for a name, address, or postal code. In some cases, the website or app supports the use of geo-positioning technologies from the mobile device to automatically zoom the map or filter the list displayed to the user. Some hotspots providers even offer an SMS (Short Message Service) based service which provides the nearest Wi-Fi hotspot location. For example, these are the instructions for Telia HomeRun: “To find the nearest surf zone where you can use Telia HomeRun, just send “homerun” as an SMS message to short number 4499—the answer will come on your mobile.” This service uses data from the mobile phone network, specifically information about the subscriber's account and the location of the radio towers in use.

None of these methods address a primary constraint with mobile devices which are battery-powered and therefore have limited power supplies, as well as CPU, memory, and storage capability. Optimization of hardware resource usage is therefore highly important.

### SUMMARY

According to one aspect of the present invention, there is provided a method of locating a wireless access node using a mobile device having wireless access technology wherein the mobile device carries out the following steps without using the wireless access technology: uses geolocation means on the mobile device to detect the position of the mobile device; compares geolocation data from the geolocation means with access node entries in a store accessible to the mobile device, each access node entry associating a wireless access node with its geolocation data; and automatically identifies a wireless access node which is indicated as a result of the comparison to be in the vicinity of the mobile device.

According to another aspect of the present invention there is provided a mobile device comprising wireless access technology; geolocation means operable to detect the position of the mobile device without using the wireless technology; a processor connected to receive geolocation data from the geolocation means and operable to execute a computer program which compares the geolocation data with access node entries in a store accessible to the mobile device, each access node entry associating a wireless access node with its geolocation data, the computer program further arranged to automatically identify a wireless access node which is indicated as a result of the comparison within the vicinity of the mobile device.

A further aspect of the invention provides a computer program product comprising code embodied on a non-transitory computer-readable medium which when executed by a processor carries out the following steps, without user intervention and without using wireless access technology: compare geolocation data from a geolocation means with access node entries in a store accessible to a mobile device, the geolocation data indicating the geographical position of the mobile device and each access node entry associating a wireless access node with its geolocation data; and automatically identifies a wireless access node which is indicated as a result of the comparison to be within the vicinity of the mobile device.

The steps of the method are preferably executed by an application executed by a processor on the mobile device without user intervention. In this way, an application can be running in the background and notify a user when there is a hotspot nearby, rather than requiring the process to be user-initiated.

An indication can be provided to a user of the mobile device that a wireless access node has been automatically identified and/or detected. This indication can be provided to a user without the user initiating a request for the indication.

In one embodiment, the wireless access technology of the mobile device is powered down while the mobile device carries out the steps of the method, and powered up to detect the wireless access node after it has been automatically identified. In other embodiments, the wireless access technology (WiFi) may be turned on for purposes other than the hotspot detection application, but nevertheless, the hotspot detection application does not use the wireless access technology even if it is turned on for other purposes.

The geolocation means can comprise a global positioning satellite system. Alternatively, the geolocation means can comprise software arranged to receive positioning data from at least one of mobile network power signals, wireless Internet signals and IP addresses, and to generate geolocation data from the positioning data.

The mobile device preferably has a display for providing the indication to a user that a wireless access node has been automatically identified or detected.

The store can be in the form of a database holding a plurality of data entries. These data entries can be downloaded from a server to the mobile device, either with the computer program product (application), or separately.

### BRIEF DESCRIPTION OF THE DRAWINGS

For a better understanding of the present invention and to show how it may be carried into effect, reference will now be made by way of example to the accompanying drawings in which:

FIG. 1 is a schematic representation of a packet-based communication system;

FIG. 2 is a schematic block diagram of a user terminal executing a communication; client application; and

FIG. 3 shows a flow chart of a hotspot detection method.

### DETAILED DESCRIPTION

In preferred embodiments, the present invention provides a method for applying geopositioning technologies to optimize the detection of public Wi-Fi hotspots from a mobile device.

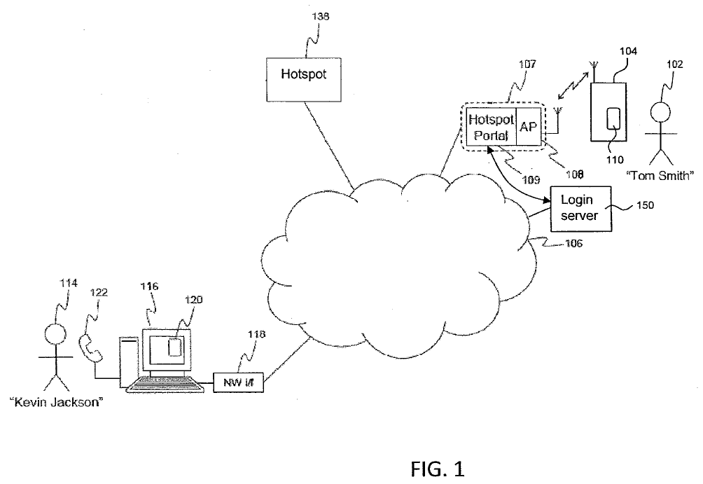

Reference is first made to FIG. 1, which illustrates a packet-based communication system 100. It should be appreciated however that while this system and method is described with reference to a packet-based communication system, the same techniques could also be applied to provide access to hotspots for other applications. Note also that while this illustrative embodiment is described with reference to a P2P communication system, other types of communication system could also be used, such as non-P2P, VoIP or IM systems. A first user of the communication system (named “Tom Smith” 201) operates a user terminal 104 which is able to connect to a packet-based network 106 such as the Internet. The user terminal 104 may be, for example, a personal computer (“PC”) (including, for example, Windows™, Mac OS™ and Linux™ PCs), a personal digital assistant (“PDA”), a mobile phone, a gaming device, a tablet or other embedded device able to connect to the network 106. The user terminal 104 is arranged to receive information from and output information to the user 102 of the device. In a preferred embodiment of the invention the user device comprises a display such as a screen and an input device such as a keyboard, mouse, joystick and/or touch-screen.

In the example shown in FIG. 1, the user terminal 104 comprises a network interface that is able to connect to a WLAN access node 107. The access node comprises an access point “AP”) 108, which provides wireless connections to the access node 107, and a hotspot portal 109, which controls whether a user terminal is able to connect to the access node 107. The AP 108 and hotspot portal 109 can be co-located in a single entity, or be provided in distinct separate entities. However, regardless of the structural layout, the functionality of the two elements is the same, such that the hotspot portal 109 controls whether a user terminal is able to connect to the packet-based network 106 (e.g. the Internet) via the AP 108. The hotspot portal 109 provides functionality such as redirection for authentication and payment. Also connected to the network 106 is a login server 150 which provides web-pages for login or related to login, to which the user is redirected by the hotspot portal 109 upon beginning the login process.

The user terminal 104 is running a communication client 110, provided by the software provider. The communication client 110 is a software program stored on a storage medium and executed on a local processor in the user terminal 104. The user terminal 104 comprises a speaker and microphone to enable the user to listen and speak in a voice call. The microphone and speaker does not necessarily have to be in the form of a traditional telephone handset but can be in the form of a headphone or earphone with an integrated microphone, as a separate loudspeaker and microphone independently connected to the user terminal 104, or integrated into the user terminal 104 itself.

Following authentication through the presentation of digital certificates (to prove that the users are genuine subscribers of the communication system—described in more detail in WO 2005/009019), a call can be made using VoIP. The client 110 performs the encoding and decoding of VoIP packets. VoIP packets from the user terminal 104 are transmitted into the network 106 via the access node 107, and routed to a computer terminal 116 of the called party 114, via a network interface 118. A client 120 (similar to the client 110) running on the user terminal 116 of the called user 114 decodes the VoIP packets to produce an audio signal that can be heard by the called user using the handset 122. Conversely, when the second user 114 talks into handset 122, the client 120 executed on user terminal 116 encodes the audio signals into VoIP packets and transmits them across the network 106 to the user terminal 104. The client 110 executed on user terminal 104 decodes the VoIP packets, and produces an audio signal that can be heard by the user of the handset 112.

The VoIP packets for calls between users (such as 102 and 114) as described above are passed across the network 106 only, and the public switched telephone network (“PSTN”) 124 is not involved. Furthermore, due to the P2P nature of the system, the actual voice calls between users of the communication system can be set up with no central servers being used. This has the advantages that the network scales easily and maintains a high voice quality, and the call can be made free to users. Additionally, calls can also be made from the client (110, 122) using the packet-based communication system to fixed-line or mobile telephones 126, by routing the call to the

PSTN network 124. Similarly, calls from fixed-line or mobile telephones 126 can be made to the packet-based communication system via the PSTN 124.

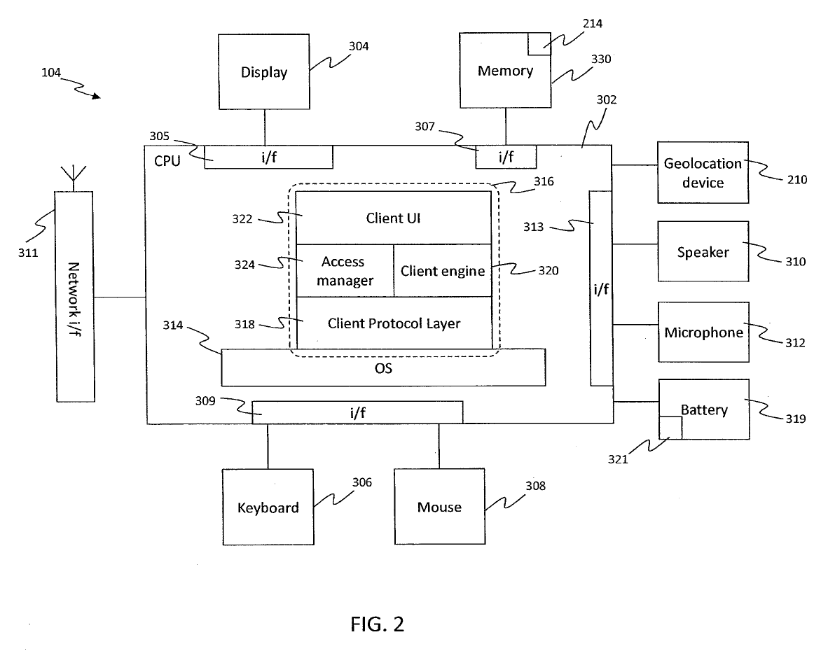

FIG. 2 illustrates a detailed view of the user terminal 204 on which is executed client 110. The user terminal 104 comprises a central processing unit (“CPU”) 302 to which is connected a memory 330 such as a flash memory and/or hard-drive connected via a memory controller interface 307. The memory 330 is installed with the communication client 110, i.e. stores the client 110 in a location in which it is made available for execution on the CPU 302. The CPU 302 is also connected to a display 304 such as a screen via a display interface 305, an output device such as a keyboard 306 and a pointing device such as a mouse 308 connected via an interface 309 such as USB. In alternative terminals, the input devices and pointing device can be integrated into the terminal, such as a keypad, touch-screen and/or joystick. An output audio device 310 (e.g. a speaker) and an input audio device 312 (e.g. a microphone) are connected via an audio interface 313. The output audio device 310 and input audio device 312 may be integrated into a handset 112 or headset, or may be separate. The CPU 302 is connected to a network interface 311 for connecting to a WLAN AP.

FIG. 2 also illustrates an operating system (“OS”) 314 executed on the CPU 302. Running on top of the OS 314 is a software stack 316 for the client 110. The software stack shows a protocol layer 318, a client engine layer 320 and a client user interface layer (“UI”) 322. Each layer is responsible for specific functions. Because each layer usually communicates with two other layers, they are regarded as being arranged in a stack as shown in FIG. 2. The operating system 314 manages the hardware resources of the computer and handles the data being transmitted to and from the network via the network interface 108. The client protocol layer 318 of the client software communicates with the operating system 314 and manages the connections over the communication system. Processes requiring higher level processing are passed to the client engine layer 320. The client engine 320 also communicates with the client user interface layer 322. The client engine 320 may be arranged to control the client user interface layer 322 to present information to the user via the user interface of the client (as shown in FIG. 2) and to receive information from the user via the user interface.

Also shown integrated into the client 110 is an access manager 324. The access manager 324 is responsible for managing access to the WLAN hotspots, as will be described in more detail hereinafter. In preferred embodiments, the access manager 324 is integrated into the client 110 and utilizes the client UI layer 322 to display information to the users, and the client protocol layer 318 to connect to the communication system. In alternative embodiments, the access manager 324, is separate but is in communication with the client 110. The terminal 104 includes a battery module 319 with a charging portal 321.

In the above description of FIG. 1 it was assumed that the user 102 knew the location of the access point 107 so that he was ready to use it for access to the network 106. However, when a user is travelling it is likely that he or she is not in the vicinity of known Wi-Fi networks (hotspots), such as at home or work. Furthermore, there may be in any particular location more than one possible hotspot available to the user (illustrated for example as hotspot 138 in FIG. 1). Due to the scarcity and time cost of battery charging opportunities, it is also likely that maximizing battery life span is even more important than usual. At the same time, it is desirable to provide an indication to the user whenever there is a public Wi-Fi hotspot nearby in case he or she wants to go on line.

In accordance with embodiments of the present invention, this is achieved by using geolocation data to sense when a user has moved in and out of the vicinity of known supported hotspots. To this end, the user terminal 104 includes a geolocation device 210 and provides a database 214 of known supported hotspots, accessible to the client 316 and/or access manager 324. The geolocation device 210 can take any suitable form. For example, GPS (Global Positioning Satellites), A-GPS and similar technologies can be used. In addition, the geolocation device can be implemented in the form of software which uses information such as mobile network tower signals, wireless internet signals and IP addresses to self-locate the user terminal 104 in a manner known per se. What is important is that the geolocation device 210 is capable of providing geolocation data which locates the user terminal with respect to a set of positioning coordinates, such as longitude and latitude coordinates, without using the radio on the terminal to locate the hotspot. The coordinates obtained by the geolocation device 210 are supplied to the client engine 320 and/or access manager 324 which is capable of comparing them with data in the database 214. The database 214 holds for each entry a hotspot identification and corresponding geolocation data, such as positioning coordinates. Thus, a comparison can be made to see whether the user is in the vicinity of a hotspot which is in the database. In this way, detection of Wi-Fi hotspots is optimized by avoiding the need to continuously scan for available Wi-Fi networks (“polling”), or even to keep the Wi-Fi radio 311 powered at all. This is advantageous, because Wi-Fi has a much higher power consumption than GPS (which is one of the possibilities for the geolocation device 210). GPS is a much simpler, receive only mechanism. It is advantageous to minimize the use of Wi-Fi whenever it is not strictly necessary, and embodiments of the present invention enable this by making use of the geolocation data determined by the geolocation device 210, in conjunction with the database of known hotspots 214.

As mentioned above the database of known supported hotspots can be stored in the memory 330 accessible by the client engine 320 and/or access manager 324. The database may be empty or prepopulated with a number of known supported hotspots, and may be updated dynamically based on the user's current location, based on knowledge of the user's itinerary, manually by the user or some combination thereof.

The database could be populated in a number of different ways. For example, where the hotspot detection method is implemented as a computer program which can be downloaded, such as an app (application), when a user downloads the app they could download in addition a “canned” database. Alternatively, it may be possible to start the application with no database or an empty one, and then require the user to connect to a server to download more data, before the hotspot detection feature of the application is usable. In practice, a combination of these techniques can be utilized to support millions of hotspots worldwide requiring a massive amount of data. Since the data changes on a daily basis, it may be preferable to export a small “canned” database of most popular hotspots, then allow a user to download fresher data and/or more data for specific regions of interest (for example, to prepare for a trip).

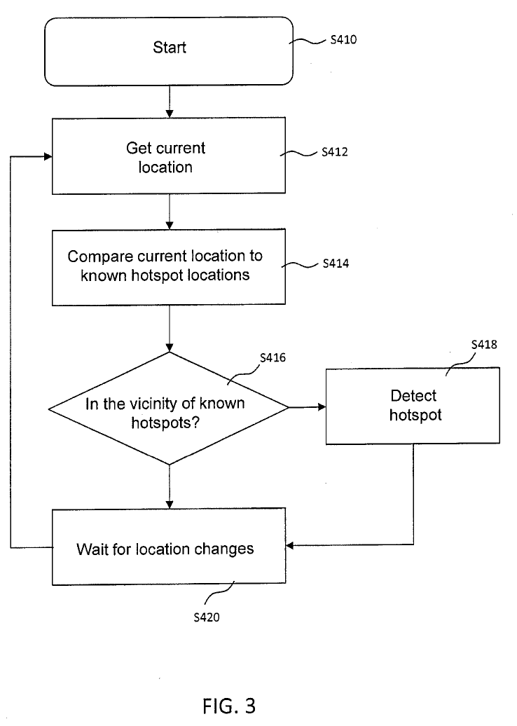

Reference will now be made to FIG. 3 to describe a method of detecting hotspots in accordance with one embodiment of the present invention. The method starts at step S410. At step S412, the current location is obtained by action with the geolocation device 210 as described above. The geolocation data is supplied from the geolocation device 210 to the client engine 320 and/or access manager 324 which compares in step S414 this data with known hotspot locations in the database 214.

If a comparison results in information that the user terminal is in the vicinity of a known hotspot (S416), the hotspot is detected by powering on the network interface 311 (if it was powered off), or by causing a poll of the network interface if it was already powered on. Once detected, an indication is given to the user on the display 304 of the user terminal that he can now connect to the internet via the detected hotspot. If the comparison at step S414 results in an indication that the user terminal 104 is not in the vicinity of a known hotspot, at step S420 the method waits for the location of the user terminal to change, and then commences again at step S412. It is also noted that while a particular hotspot has been detected, should the user terminal 104 change its position, this is similarly detected at step S420 and the method reverts to step S412. In this way, a user terminal is automatically kept in touch with available hotspots in its vicinity.

Thus, embodiments of the present invention allow for the optimized detection of public Wi-Fi hotspots in the manner of an automatic search process that does not require user interaction, such as checking a map, browsing a list or entering a query string.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer-readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method of locating a wireless access node using a mobile device having wireless access technology, wherein the mobile device carries out the following steps without using the wireless access technology:
uses geolocation means on the mobile device to detect the position of the mobile device;
compares geolocation data from the geolocation means with access node entries in a store accessible to the mobile device, each access node entry associating a wireless access node with its geolocation data; and
automatically identifies a wireless access node which is indicated as a result of the comparison to be in the vicinity of the mobile device.

2. A method according to claim 1, wherein the steps are executed by an application executed by a processor on the mobile device without user intervention.

3. A method according to claim 1, wherein the store comprises a database on the mobile device, comprising the step of downloading a set of data entries for the database from a server to the mobile device, optionally with the application.

4. A method according to claim 1, wherein the store comprises a database on the mobile device.

5. A mobile device according to claim 7, wherein the geolocation means comprises a global positioning satellite system.

6. A method according to claim 1, wherein the wireless access technology of the mobile device is powered down while the mobile device carries out the aforesaid steps, and comprising the step of powering up the wireless access technology to detect the wireless access node after it has been automatically identified.

7. A mobile device comprising:
wireless access technology;
geolocation means operable to detect the position of the mobile device without using the wireless technology;
a processor connected to receive geolocation data from the geolocation means and operable to execute a computer program which compares the geolocation data with access node entries in a store accessible to the mobile device, each access node entry associating a wireless access node with its geolocation data, the computer program further arranged to automatically identify a wireless access node which is indicated as a result of the comparison within the vicinity of the mobile device.

8. A mobile device according to claim 7, wherein the geolocation means comprises a global positioning satellite system.

9. A mobile device according to claim 7, wherein the geolocation means comprises software arranged to receive positioning data from at least one of mobile network power signals, wireless internet signals and IP addresses and to generate geolocation data from said positioning data.

10. A mobile device according to claim 7, which comprises a battery for powering the device.

11. A mobile device according to claim 7, which comprises a display for providing an indication to a user that a wireless access node has been automatically identified.

12. A computer program product comprising code embodied on a non-transitory computer-readable medium which when executed by a processor carries out the following steps, without user intervention and without using wireless access technology:
compare geolocation data from a geolocation means with access node entries in a store accessible to a mobile device, the geolocation data indicating the geographical position of the mobile device and each access node entry associating a wireless access node with its geolocation data; and
automatically identifies a wireless access node which is indicated as a result of the comparison to be within the vicinity of the mobile device.
